(19) United States
(12) Patent Application Publication
(10) Pub. No.: US 2006/0103627 A1
(43) Pub. Date: May 18, 2006

(54) Information displaying device

(76) Inventors: Junichiro Watanabe, Tokyo (JP); Takeshi Hoshino, Kodaira (JP); Yukinobu Maruyama, Kokubunji (JP); Hiroko Sukeda, Tokorozawa (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/274,421

(22) Filed: Nov. 16, 2005

(30) Foreign Application Priority Data
Nov. 17, 2004 (JP) 2004-332577

(51) Int. Cl. G09G 5/00

(52) U.S. Cl. 345/156

(57) ABSTRACT

The conventional mirror shows only a reflected image. For example, a user who looks at the same mirror at a face-washing place at home every day can see only the similar reflected image. The present invention provides an information displaying device capable of displaying information which can be displayed by the primary function and information which can be displayed by another function on the same display unit. The information displaying device includes a projector for projecting video, a display unit for displaying the video, and a diffusion layer attached to the display unit for diffusing the light projected from the projector. The display unit displays not only a reflected image on the front side of display surface but also video and characters projected by the projector from the rear side of the display unit.

### CLAIM OF PRIORITY

The present application claims priority from Japanese application JP 2004-332577 filed on Nov. 17, 2004, the content of which is hereby incorporated by reference into the application.

### BACKGROUND OF THE INVENTION

The present invention relates to an information displaying device not only showing a reflected image but also displaying various kinds of information on a mirror surface.

Mirrors are used in various places for various purposes such as in a bathroom where appearance is checked, in a clothing shop where a commodity is checked, in a barbershop, or on a column of a building where people gathered. Moreover, half mirrors through which the front side can be viewed from the back side are used as sun visors for windows of a building and a vehicle or in stores for anticrime purpose.

Up to now, the mirror has been used only for showing a reflected image. For example, when a user looks at the mirror at a face-washing place at home, the user can see only the similar reflected image. As compared to this, if additional information other than the reflected image such as the weather forecast and new can be displayed on the mirror surface, the user can get different information every day.

As a mirror having such a function, for example, JP-A-2002-229494 suggests “a mirror with information display function”. This is a half mirror having a liquid crystal display on the rear surface of the half mirror for displaying a liquid crystal display video on the mirror surface through the half mirror when the liquid crystal display is ON. Thus, it is possible to display additional information such as an image and characters in addition to the reflected image.

### SUMMARY OF THE INVENTION

The method of “mirror with information display function” disclosed in JP-A-2002-229494 has a problem that brightness of the image displayed on the mirror surface is lowered if the liquid crystal display as a light source is not in the vicinity of the half mirror and a problem that the viewing angle is limited to the size of the display.

Moreover, the “mirror with information display function” disclosed in JP-A-2002-229494 suggests an example of projection of an image by a projector instead of the liquid display. However, the display unit of the JP-A-2002-229494 is only a half mirror covered by a protection transparent layer and has a defect that the projected image is actually not seen by the user's eyes and the electric bulb of the projector as a light source is directly seen.

The present invention solves these problems. The first object of the present invention is to provide an information displaying device capable of displaying not only a reflected image but also information other than the information provided by the primary function on the mirror surface at a certain timing of an object and time to be displayed on the mirror. Moreover, the second object of the present invention is to provide an information displaying device as described in the first object, the device including a display unit having a function to spread light capable of displaying a video on the display unit even when the light source is apart from the display unit. Furthermore, the third object of the present invention is to provide a video displaying device as described in the first object, the device being capable of displaying a video regardless of the size of the plane where video is displayed.

In order to achieve the aforementioned objects, the present invention provides an information displaying device including a unit for projecting information such as video from the rear side of the half mirror and a unit for displaying the projected video.

Moreover, the present invention employs a projector capable of limiting the viewing angle of the projected video as the video projection unit.

Moreover, the present invention includes a video display unit having a reflection layer such as a mirror surface and a diffusion layer for diffusing the projected light as a unitary block so that the light source is not seen directly when the user looks at the video display unit such as the mirror surface.

Moreover, the present invention includes a unit for imaging a person or an object as a video signal from the rear side of the half mirror, an image processing unit for analyzing the acquired image and recognizing, for example, a person's face, a unit for representing video information and audio information in accordance with the image processing result, and a unit for memorizing information such as the video.

Moreover, the present invention further includes a sensor for detecting when a person or an object approaches within a predetermined distance and a unit for presenting video information and audio information in accordance with the information from the sensor.

Moreover, the present invention further includes a reader for reading tag information such as an RFID (Radio Frequency Identification), a unit for memorizing various kinds of information linked to the tag, and a unit for calling and presenting the information.

By superimposing the half mirror and the diffusion layer for displaying the projected image from the rear side of the half mirror on each other, it is possible to display the reflected image and the projected image overlapped on the display unit. Moreover, by using a projector to project onto the diffusion layer, it is possible to obtain more flexibility in the kind of devices arranged at the rear side of the half mirror and the installation position as compared to the case when the half mirror is used in combination with a liquid crystal screen. Especially, in order to install a camera imaging the front side (user side) of the half mirror when using a liquid crystal screen, the camera-should be arranged outside the frame of the liquid crystal screen or the camera should be embedded in a part of the liquid crystal screen to sacrifice the part. As compared to this, according to the method of the present invention, the camera can be installed anywhere. The camera can be arranged near to the projector and can easily image an object at the front side of the display unit and project a screen utilizing it while easily making adjustment between the reflected image and the projected image. For example, by arranging an infrared camera near the projector, it is possible to detect a contour of a person or other object present in the vicinity of the mirror and project video in accordance with the contour.

For example, the user can know the weather forecast displayed on the mirror surface while checking at the face-washing place every morning. In a shop, only by holding the clothes having an RFID tag in front of the mirror, the user can check her figure automatically coordinated by a hat and a skirt matched with the clothes. It is also possible to check the face image acquired by a camera from the rear side of the mirror and focus the non-shaven portion on the face.

Moreover, when using a thin wooden plate instead of the mirror surface, the plate of grain pattern is simply seen when the power of the projector arranged at the rear side of the wooden plate is OFF and information can be displayed on the plate of the wooden grain pattern when the power of the projector is ON.

Furthermore, when paper is used instead of the mirror surface, the user can see only the information printed on the paper when the projector power is OFF but the user can see not only the information printed on the paper but also the information projected from the rear side when the projector power is ON.

Other objects, features and advantages of the invention will become apparent from the following description of the embodiments of the invention taken in conjunction with the accompanying drawings.

### BRIEF DESCRIPTION OF THE DRAWINGS

FIG. 1 shows outline of an information displaying device according to the present invention.

FIG. 2 shows an example of information display of the information displaying device according to the present invention.

FIG. 3A and FIG. 3B show the effect of a diffusion layer used in the information displaying device according to the present invention. FIG. 3A shows a case when the half mirror has no diffusion layer and FIG. 3B shows a case when the half mirror has a diffusion layer.

FIG. 4A shows the diffusion layer used in the information displaying device according to the present invention and show an example of a diffusion film of the vertical direction.

FIG. 4B shows the diffusion layer used in the information displaying device according to the present invention and show an example of the diffusion film of the horizontal direction.

FIG. 4C shows the diffusion layer used in the information displaying device according to the present invention and show an example of the diffusion film of the vertical-horizontal direction.

FIG. 5 shows a display range of the information displaying device according to the present invention: The left side of FIG. 5 is a front view, The Center of FIG. 5 is a side view, and The right side of FIG. 5 is a top view.

FIG. 6A to FIG. 6B show an example of the information displaying device according to the present invention using a camera; FIG. 6A is a cross sectional view, FIG. 6B is front views.

FIG. 7 shows an example using a sensor of the information displaying device according to the present invention.

FIG. 8 shows a flow of processing of an example using the sensor of the information displaying device according to the present invention.

FIG. 9A and FIG. 9B show an example using the RFID tag of the information displaying device according to the present invention: FIG. 9A is a cross sectional view and FIG. 9B is a front view.

FIG. 10 shows a processing of an example using the RFID tag of the information displaying device according to the present invention.

FIG. 11 shows processing of an example using a thin wooden plate as a display unit of the information displaying device according to the present invention: The left side of FIG. 11 is a cross sectional view, (a) is a front view when the projector power is OFF, and (b) is a front view when the projector power is ON.

FIG. 12 shows an example when paper is used as the display unit of the information displaying device according to the present invention: The left side of FIG. 12 is a cross sectional view, (a) is a front view when the projector power is OFF, and (b) is a front view when the projector power is ON.

FIG. 13 shows a structure of the display unit of the information displaying device according to the present invention.

### DETAILED DESCRIPTION OF THE EMBODIMENTS

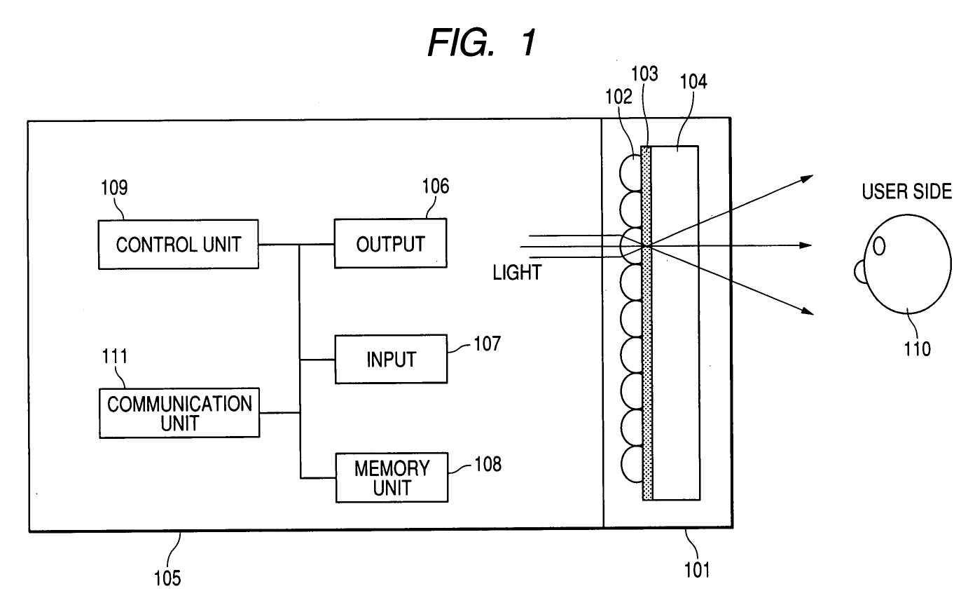

Description will now be directed to embodiments of the present invention with reference to the attached drawings. FIG. 1 shows an outline of configuration of the first embodiment of the present invention including a display unit 101 such as a mirror for displaying a reflected image and a projected image, a diffusion layer 102 such as a diffusion film for diffusing light as one constituent element, a reflection layer 103 such as a deposited metal for reflecting the light from the user side 110 as one constituent element of the display unit 101, a transparent member 104 such as a mirror substrate for transmitting light as one constituent element of the display unit 101, a surrounding 105 for storing the light source such as a projector in a dark place, an output 106 of the projector for projecting a video, an input 107 for reading information such as a camera, a sensor and an RFID tag, a memory unit 108 for memorizing various kinds of information such as video data, and a control unit 109 for controlling the output 106, the input 107, and the memory unit 108. There may also be provided a communication unit 111 to be connected with the Internet for performing data communication.

In FIG. 1, when the projector power is OFF, a reflected image, for example, the user himself/herself reflected by the reflection layer 103 is displayed on the surface of the transparent member 104. In FIG. 1, when the projector power is ON, in addition to the reflected image, a projected image from the projector is diffused in the diffusion layer 102, passes through the reflection layer 103, and is displayed on the surface of the transparent member 104. The video information projected from the projector may be memorized in the memory unit of a computer and may be downloaded via the Internet.

In FIG. 1, the output 106 such as the projector is arranged in a surrounding 105 such as a box cutting off advance of light, for example so that light other than from the output 106 is not projected from the output 106 side of the display unit 101 to the display unit 101. Moreover, in FIG. 1, in stead of the reflection layer 103 and the transparent member 104, it is possible to use a thin wood and paper. In this case, since the thin wood and paper have an effect to diffuse light, the light projected by the projector is diffused and an image can be displayed on the surface. That is, when the projector power is OFF, the user can see the grain or the information printed on the paper and when the projector power is ON, the user can see the information projected by the projector.

Moreover, in FIG. 1, it is possible to adjust the viewing angle of the projector 106 and it is possible to display video while maintaining brightness on the surface having various areas with different longitudinal and lateral lengths.

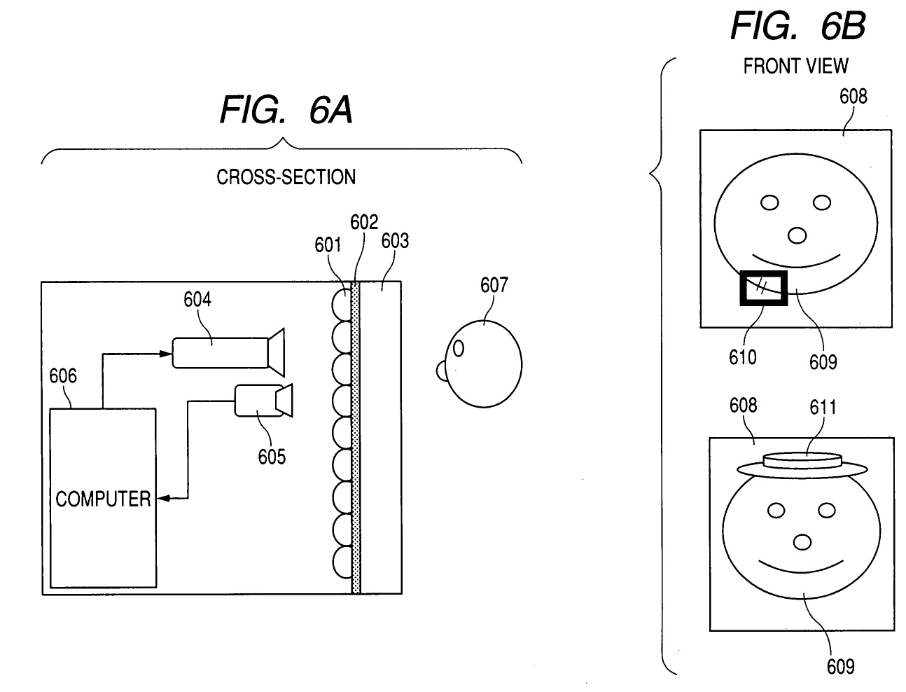

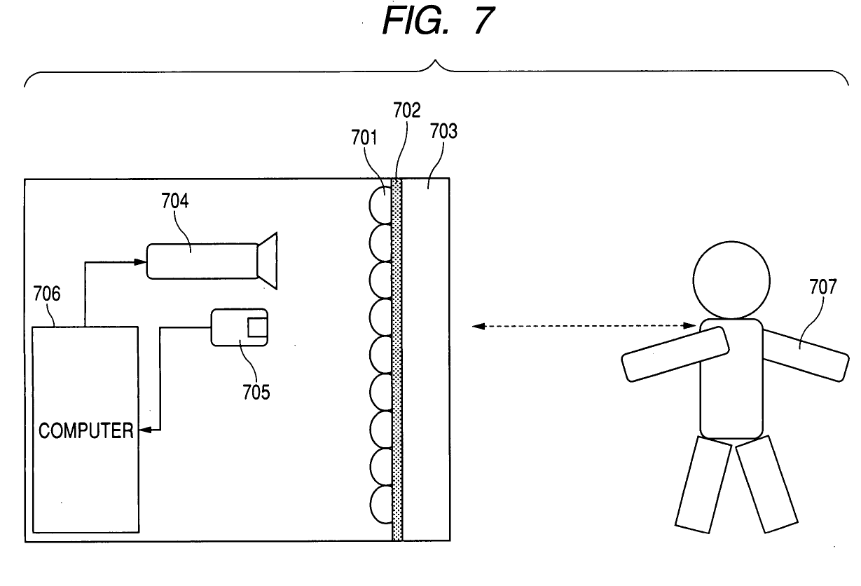

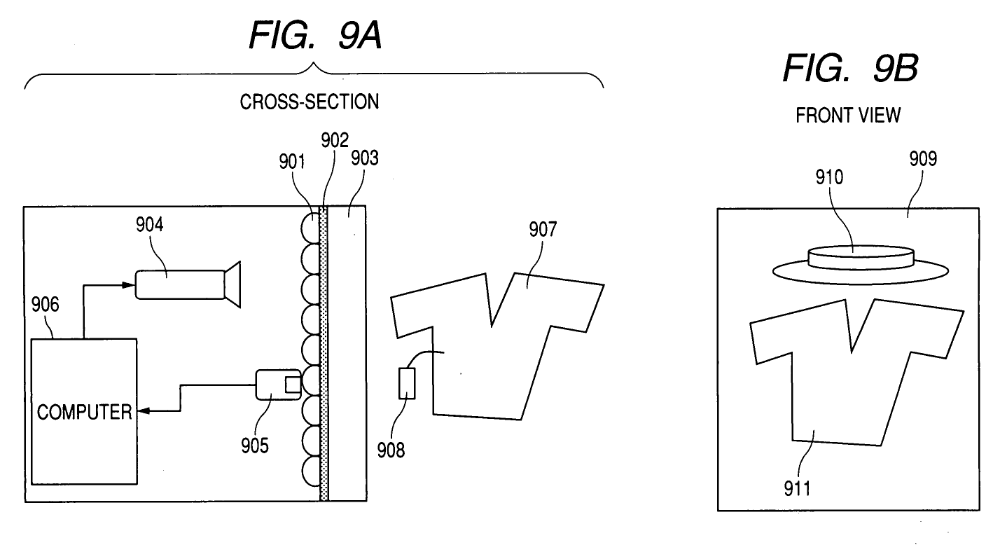

Moreover, in FIG. 1, the distance between the light source and display unit 101 can be set at an arbitrary value. Accordingly, as shown in FIG. 6, FIG. 7, and FIG. 9, the camera and the sensors can be arranged on the rear surface of the information display unit.

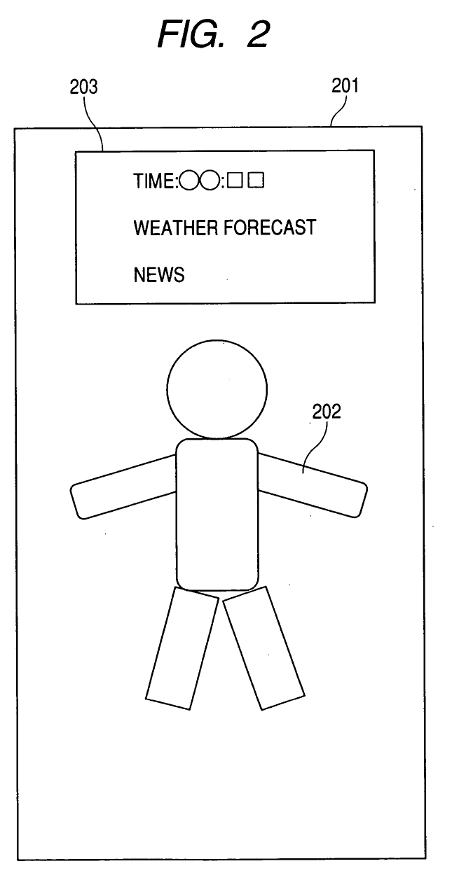

FIG. 2 shows an information display example which the user can see. 201 is an information display unit such as a mirror surface, 202 is a reflected image such as user himself/herself, and 203 is information projected from the rear surface of the display unit. Thus, the reflected image and the projected image projected can be displayed on a single surface even superimposed if necessary. In FIG. 1, the information 203 projected from the rear surface of the display unit may be video, characters, or any other information.

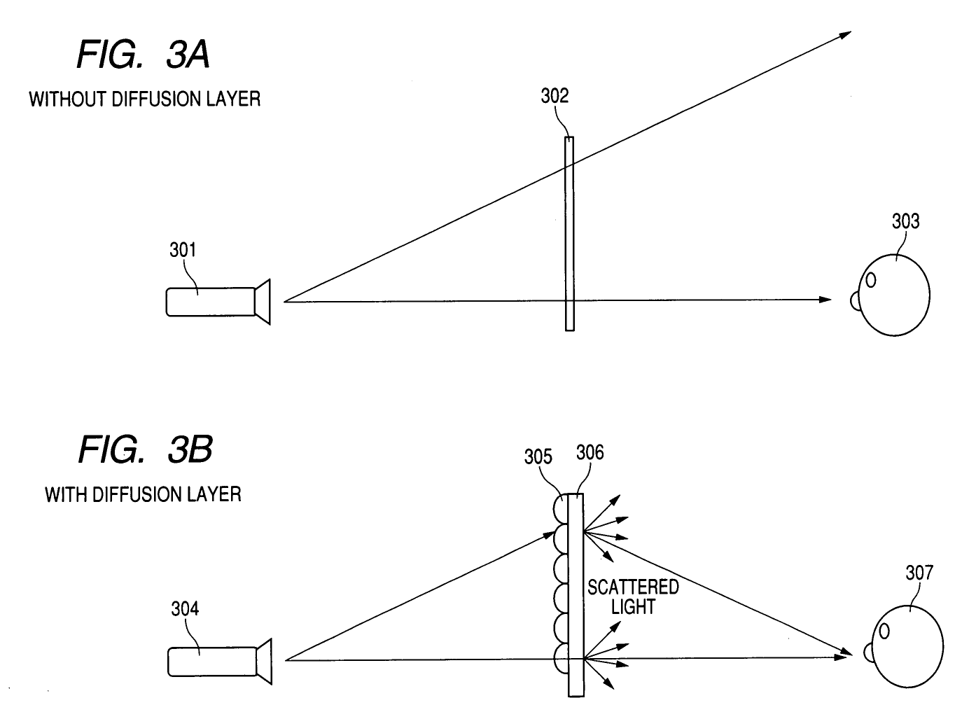

FIG. 3A and FIG. 3B shows the effect of the diffusion layer 102 constituting the display unit 101. In FIG. 3A and FIG. 3B, 301, 304 are projectors, 302, 306 are transparent reflection layers such as half mirrors, 303, 307 are persons who look at the information displayed, and 305 is a diffusion layer.

The optical path is different when the diffusion layer 305 is present and when the diffusion layer 305 is absent. When the diffusion layer 305 is absent, the light passes through the transparent reflection layer 302. Accordingly, the person 303 can directly see the light source 301 and only the light coming toward the user's eyes from the light source reaches the user's eyes. Accordingly, the user can perceive only that point and cannot see the information such as video on the surface of 302. As compared to this, when the diffusion layer 305 is present as in FIG. 3B, the light is diffused by the diffusion layer 305 and image is formed on the surface of 302. The light source 304 is not directly seen by the eyes of the person 307. Since light other than the straight light also reaches the user's eyes, the user can see a wider range, for example, the projected image on the entire screen.

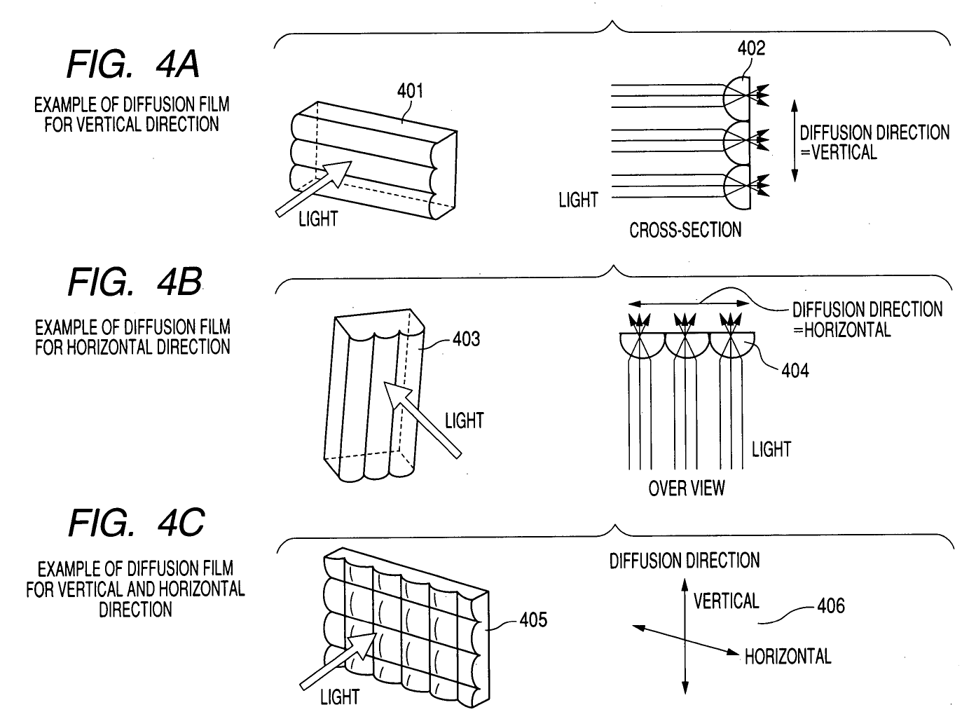

FIG. 4A to FIG. 4C show an example of diffusion film constituting a diffusion layer. Depending on the light diffusion directions, explanation will be given on three cases. FIG. 4A explains a case when the light is diffused in the vertical direction: 401 explains the shape of diffusion film, and 402 is a cross sectional view of the diffusion film in the vertical direction. In FIG. 4A, the advance direction of the incident light is refracted to vertical direction by the film convex surfaces.

Similarly, FIG. 4B explains a case when the light is diffused in the horizontal direction: 403 explains the shape of diffusion film, and 404 is a cross sectional view of the diffusion film in the horizontal direction. In FIG. 4B, the advance direction of the incident light is refracted to horizontal direction by the film convex surfaces.

FIG. 4C explains a case when the light is diffused in the vertical direction and the horizontal direction: 405 explains the shape of diffusion film, and 406 shows the light diffusion direction. In FIG. 4B, the advance direction of the incident light is refracted to horizontal direction by the film convex surfaces. FIG. 4C has characteristics combining FIGS. 4A and 4B. As shown in FIG. 4C, concave shape is formed in both of the vertical direction and the horizontal direction. The same effect can be obtained by simply superimposing FIG. 4A and FIG. 4B instead of FIG. 4C.

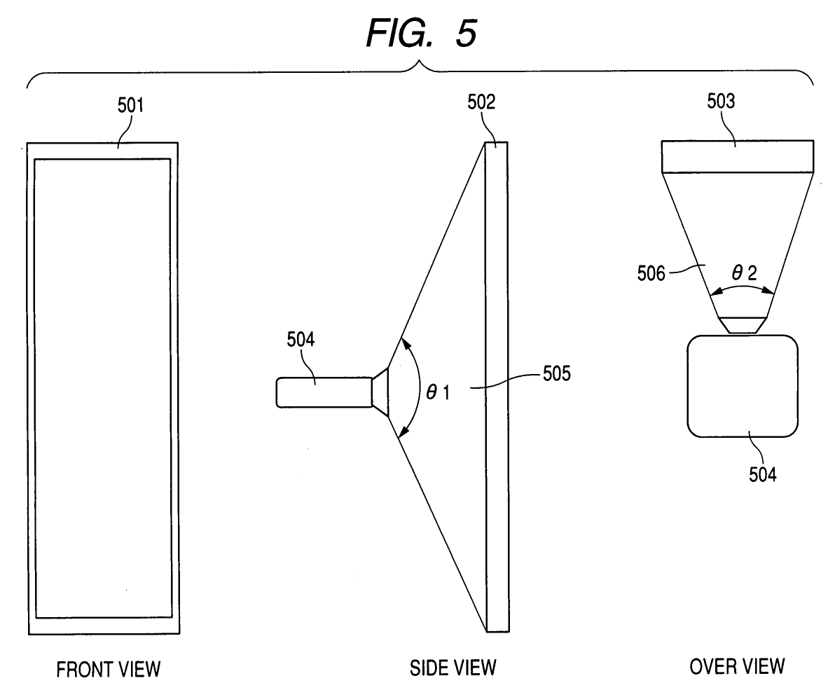

FIG. 5 shows an example of the information displaying device having a display surface longer than wide light a full-length mirror. 501 is front view, 502 is a side view, and 503 is top view of the information display device. Moreover, since the viewing angle of the projector 504 can be adjusted with the angle 505 θ1 in vertical direction and the angle 506 θ2 in the right-left direction, it is possible to display on a surface of various shapes including the surface having a small width and large length such as a full-scale mirror.

FIG. 6A to FIG. 6B show an example in which a camera is provided in the rear side of the information display unit. In FIG. 6A, 601 is a diffusion layer, 602 is a reflection layer, 603 is a transparent member, 604 is a projector, 605 is a camera, 606 is a computer, and 607 is user. FIG. 6B is a front view of the device viewed by the user. 608 is a transparent member, 609 is a reflected image, and 610, 611 are information projected by the projector 604. The video acquired by the camera 605 is subjected image processing by the computer 606 and the corresponding video is outputted from the projector 604. As the image of the image processing result, for example, beard now shaven is detected and it is displayed at the shave-forgotten position on the reflected user's face by superimposing the cursor 610 there. Moreover, it is possible to display a hat image 611 matched with the reflected position of the user's face 609 as the reflected image, thereby utilizing it as a virtual full-scale mirror.

When a high resolution is not required when imaging the front side of the display unit, it is possible to image through the diffusion film and the camera can be arranged almost at the same position as the projector. In this case, it is possible to detect a contour by an infrared camera or distinguish a contour by using software distinguishing the visible light and a shade by a normal camera. For application requiring a high resolution, the camera is arranged outside the display unit so that imaging can be acquired without passing through the diffusion film or the display unit has a part where no diffusion film is attached and a camera is arranged there. When arranging the projector and the camera apart from each other, positioning is required for creating a projected image from the projector by utilizing the camera image.

FIG. 7 shows an example for detecting an approach of a person within a certain distance by using an infrared sensor and displaying information by using the detection signal as a trigger. In FIG. 7, 701 is a diffusion layer, 702 is a reflection layer, 703 is a transparent member, 704 is a projector, 705 is a sensor, 706 is a computer, and 707 is a user. In FIG. 7, as the sensor used for detection of the distance, it is possible to use other means such as a wireless LAN instead of the infrared sensor. In FIG. 7, when a signal detecting an approach of a person is inputted to the computer 706 by the sensor 705, the computer reads out information from the memory unit containing data such as video and outputs it from the projector 704. For example, the information displaying device of the present invention is arranged on the wall of a shop so that it serves as a mirror when a client is at a position farther than a certain distance and serves as a system displaying shop information and commodity information on the mirror surface when the client approaches the mirror.

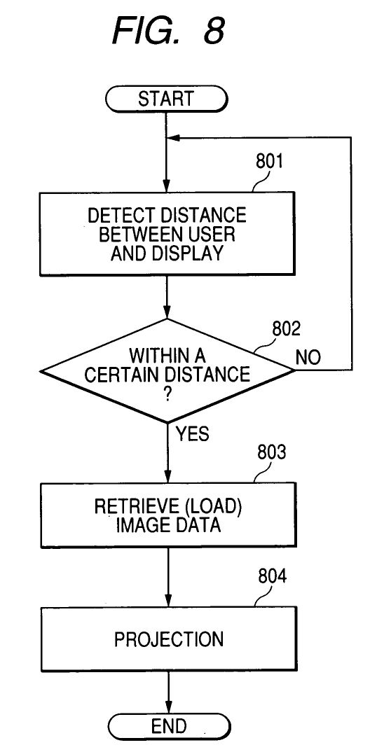

Referring to FIG. 8, explanation will be given on the flow of processing when displaying information by using a sensor detecting approach of a person. In FIG. 8, in step 801, a distance between the device and a person is measured. When step 802 decides that the distance is longer than a predetermined distance, the distance measurement is repeated. When step 802 decides that the person approaches within the predetermined distance, video data memorized in the computer memory unit is retrieved (loaded) in step 803, and is outputted from the projector in step 804.

FIG. 9A and FIG. 9B show an example of using a reader reading an RFID tag and displaying information corresponding to the tag information. In FIG. 9A, 901 is a diffusion layer, 902 is a reflection layer, 903 is a transparent member, 904 is a projector, 905 is a reader of the RFID tag, 906 is a computer, 907 is an object such as clothing, and 908 is an RFID tag attached to the object 907. In FIG. 9B, 909 is a front view of the information display screen, 910 is a video projected from the projector 904, and 911 is a reflected image.

For example, in a shop, an RFID tag 508 is attached to clothing 907 as a commodity. When the clothing is brought near to the reader 505, the tag information is read and the memory unit of the computer 906 outputs a hat, for example, matched with the clothing 907 from the projector 904. Moreover, in FIG. 9B, on the mirror surface 909, the hat 910 matched with the clothing 911 is displayed so as to automatically check the appearance after coordinating.

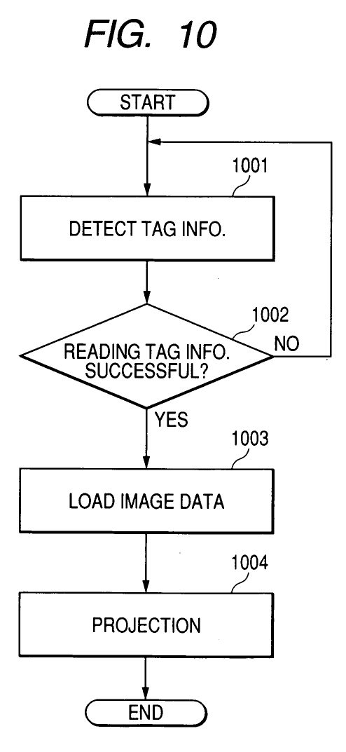

Referring to FIG. 10, explanation will be given on an example of information display using the RFID reader. In FIG. 10, step 1001 reads tag information. When the reading has failed, nothing is performed in step 1002. When the reading is successful in step 1002, information such as video data memorized in the memory unit of the computer is loaded in step 1003 and outputted from the projector in step 1004.

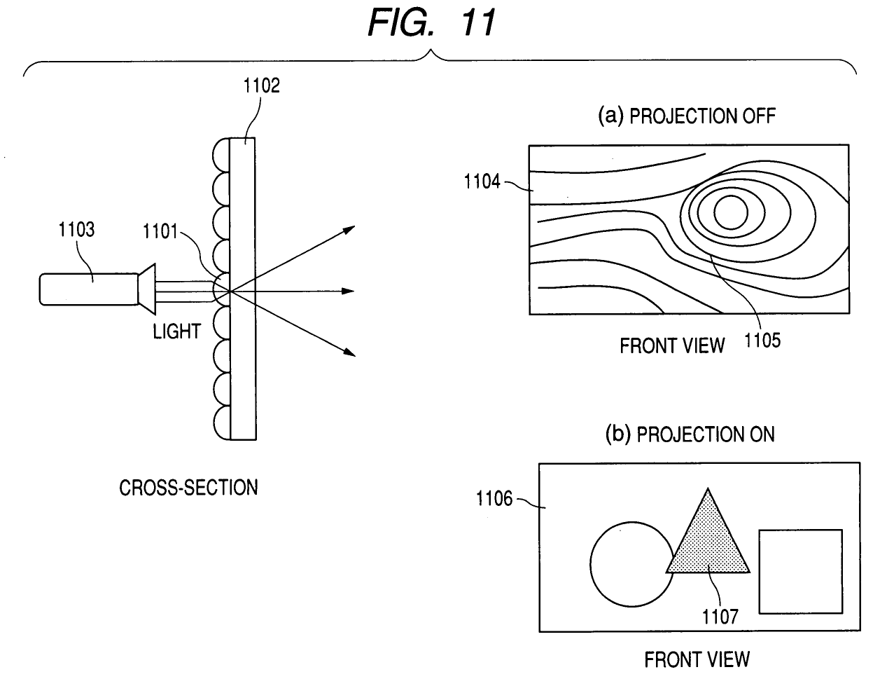

FIG. 11 explains a case when a thin wooden plate is used for the display unit of the information displaying device of the present invention. 1101 is a diffusion layer, 1102 is a thin wooden plate, and 1103 is a projector. The light projected from the projector 1103 is diffused by the diffusion layer 1101 and the thin wooden plate 1102.

Moreover, in FIG. 11(a), 1104 is a front view of the display unit when the power of the projector 1103 arranged at the rear side of the display unit is OFF and the user can see the pattern 1105 of the wooden material such as grain. On the other hand, in FIG. 11(b), 1106 a front view of the display unit when the power of the projector 1103 arranged at the rear side of the display unit is ON and the user can see data 1107 such as vide projected from the projector on the surface of the thin wooden plate.

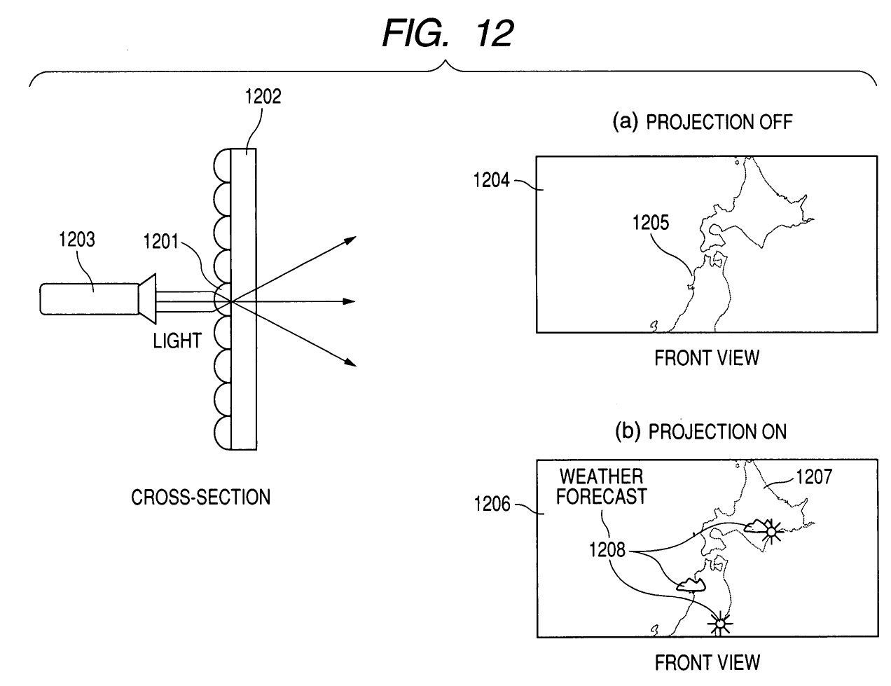

FIG. 12 explains a case when paper is used for the display unit of the information displaying device of the present invention. In FIG. 12, 1201 is a diffusion layer, 1102 is paper, and 1203 is a projector. Moreover, in FIG. 12(a), 1204 is a front view of the display unit when power of the projector 1203 arranged at the rear side of the display unit is OFF and the user can see FIG. 12(a), 1205. In the example of FIG. 12(a), 1205 represents a map printed on paper, as an example, but it can be other diagram or characters.

On the other hand, in FIG. 12(b), 1206 is a front view of the display unit when power of the projector 1203 arranged at the rear side of the display unit is OFF and the user can see data 1208 such as video projected from the projector which is superimposed on the printed FIG. 1207. In the example of FIG. 12(b), characters telling weather forecast and FIG. 12(b), 1208 are superimposed on the printed map of FIG. 12(b), 1207. The information projected from the projector 1203 may be other video or characters.

Explanation has been given on the structure of the information display unit of the information displaying device of the present invention in the order of the diffusion layer, the reflection layer, and the transparent member from the side of the light source such as the projector. However, the diffusion layer may be arranged at the user side of the display unit. That is, the same effect can be obtained by the structure having the reflection layer, the transparent member, and the diffusion layer in this order from the side of the light source such as a projector.

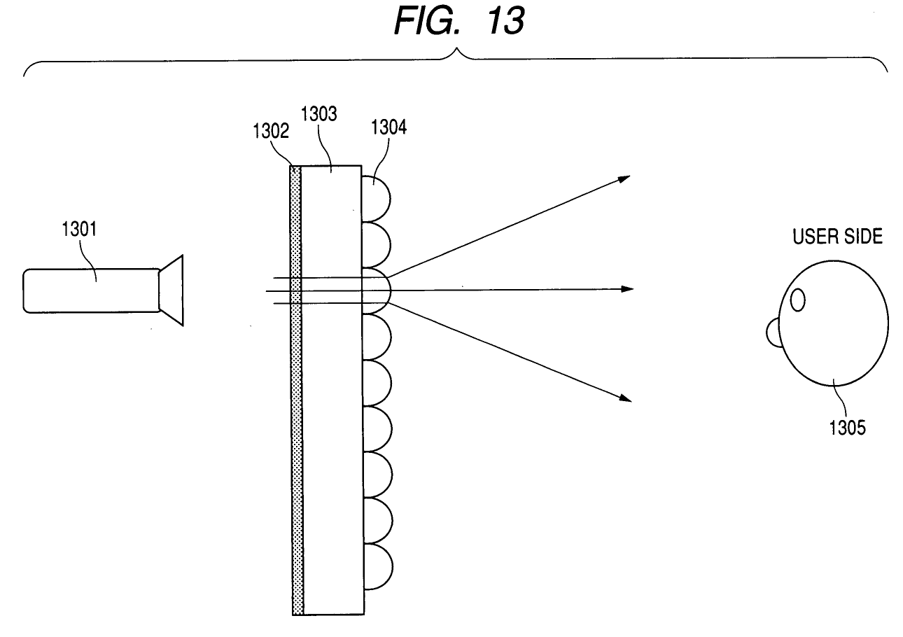

FIG. 13 explains another example of the structure of the display unit. 1301 is a projector, 1302 is a reflection layer, 1303 is a transparent member, 1304 is a diffusion layer, and 1305 is a user. The light projected from the projector 1301 is diffused by the diffusion layer and reaches the eyes of the user 1305.

It should be further understood by those skilled in the art that although the foregoing description has been made on embodiments of the invention, the invention is not limited thereto and various changes and modifications may be made without departing from the spirit of the invention and the scope of the appended claims.

1. An information displaying device comprising:
a projector for projecting a video; and
a display unit having a diffusion layer for diffusing the light projected from the projector and a half mirror which are superimposed on each other,
wherein the display unit displays a reflected image on the front side of the display surface reflected by the half mirror and video and characters projected by the projector from the rear side of the display surface.

2. The information displaying device as claimed in claim 1, wherein a camera is arranged on the rear side of the display unit so that video of the front side of the display unit is imaged.

3. The information displaying, device as claimed in claim 1, wherein a sensor is arranged at the rear side of the display unit for detecting a distance to a person who has approached the front side of the display unit and displaying information such as video when the person approaches a predetermined distance.

4. The information displaying device as claimed in claim 1, wherein a reader is arranged at the rear side of the display unit for reading tag information when an object having a tag such as the RFID comes near to the display unit and displaying the corresponding information on the display unit.

5. The information displaying device as claimed in claim 1, wherein video of size matched with the display unit is displayed without lowering brightness by limiting the viewing angle by the projector.
